(19) United States
(12) Patent Application Publication
(10) Pub. No.: US 2008/0244440 A1
(43) Pub. Date: Oct. 2, 2008

(54) RIBBON-STYLE USER INTERFACE FOR A SOFTWARE APPLICATION

(76) Inventors: Wynn Bailey, Cloverdale, CA (US); Brenda Dillon, Altadena, CA (US); Matthew Labarge, Toronto (CA); John Taylor, Fullerton, CA (US); Khushwant Gill, Anaheim Hills, CA (US); Donald S. Lloyd, Point Reyes Station, CA (US); Wade M. Person, Huntington Beach, CA (US)

Correspondence Address: AVERY DENNISON CORPORATION;Patent Group, Law Department - 3 South, P.O. BOX 7090, PASADENA, CA, 91109-7090, US

(21) Appl. No.: 12/056,902

(22) Filed: Mar. 27, 2008

Related U.S. Application Data
(60) Provisional application No. 60/908,672, filed on Mar. 28, 2007.

(51) Int. Cl. G06F 3/048

(52) U.S. Cl. 715/777

(57) ABSTRACT

An electronic document generated in a software application is formatted for printing on a particular product using an executable template which is pre-designed with a set of template parameters. To assist the user in modifying the document, a ribbon-style user interface is configured to execute within the software application directly above the viewing area of the active document. The ribbon-style user interface includes a plurality of stacked tabs, each tab displaying task-related groupings of easily accessible functionality controls. The user interface includes a template tab which is provided with at least one grouping of controls which directly relates to the modification of the active template parameters attributed to the printable electronic document. In order to optimize functionality of the template tab, the controls provided on the template tab are customized for the intended product on which the document is to be printed.

### CROSS-REFERENCE TO RELATED APPLICATIONS

The present application claims the benefit under 35 U.S.C. 119(e) of U.S. provisional Patent Application Ser. No. 60/908,672, filed Mar. 28, 2007, entitled “Ribbons With Optimized Features For Formatting Printable Products” by Wynn Bailey, Brenda Dillon, Matthew Labarge, John Taylor, Khushwant Gill, Donald S. Lloyd, and Wade M. Person, the disclosure of which is incorporated herein by reference.

### BACKGROUND OF THE INVENTION

The present invention relates generally to user interfaces for software applications and more particularly to ribbon-style user interfaces for software applications.

Word processing is a well-known software application which can be used to generate printable electronic documents. To assist in the process of generating printable documents, most conventional word processing applications are programmed to include a large quantity of functionality controls (e.g., cut, copy, paste, underline and bold). In order to maximize the viewing area of an active document, functionality controls for such an application are commonly accessed through a condensed user interface (UI), such as a toolbar, menu or task pane, which extends along one edge of the screen display.

To reduce their overall size, user interfaces of the type described above are often provided as elongated bars on which are displayed a limited number of menu headings (e.g., file, edit, view, insert, format), each heading broadly identifying a category, or group, of related controls that are available within the application. In order to access a particular control, the user is required to select one of the menu headings from the bar (e.g., by clicking on or by moving a cursor directly over the heading). Activation of the heading releases a drop-down, or pull-down, menu of available controls from the bar. If necessary, the user interface may be configured to release additional drop-down menus from the original drop-menu to accommodate more controls. Once a particular functionality control is located by the user on a drop-down menu, activation is achieved by clicking on the desired control.

As can be appreciated, user interfaces of the type described above often utilize a rather complex hierarchy of pull-down menus. Furthermore, it should be noted that once a particular control has been selected by the user (or if the user simply clicks back on the main application workspace), all activated drop-down menus are retracted back into the into the main bar. Accordingly, controls that are frequently utilized by a user during the course of generating of a printable document often necessitate constant navigation through multiple levels of drop-down menus which in turn has been found to be both highly cumbersome and time-consuming in nature.

Accordingly, Microsoft Corporation of Redmond, Wash. has created a ribbon-style user interface and, in turn, implemented said user interface into a suite of its software applications (namely, Microsoft® Office 2007). The ribbon-style user interface (also referred to in the art simply as “the ribbon” or “ribbon”), is similar to a conventional toolbar in that it executes within an application and extends horizontally above the viewing area of the active document. Examples of ribbons are disclosed in U.S. Patent Application Publication No. 2006/0036964 to J. C. Satterfield et al. and U.S. Patent Application Publication No. 2007/0055943 to M. J. McCormack et al., both of said references being incorporated herein by reference.

The ribbon differs principally from a traditional toolbar in that the ribbon comprises a plurality of individual functionality tabs, each tab being dimensioned to display a considerable number of functionality controls. Specifically, each tab is preferably configured as an enlarged rectangular pane, or window, which is approximately four times the height of a conventional toolbar. In this manner, a relatively large quantity of controls can be displayed directly on each tab.

The plurality of ribbon tabs is represented in stacked form, with a maximum of one tab viewable at any given time. Each tab is identified, or marked, with a particular heading which remains viewable at all times, each heading defining the particular groups, or categories, of task-related functionality controls that are provided thereon. For example, the ribbon may include tab headings which include, but are not limited to, “home”, “insert”, “page layout”, “references”, “mailings”, “review” or “view”. In furtherance of the example, the aforementioned “home” tab may be provided with various commonly-used clipboard controls, such as cut, copy and paste, as well as various commonly-used font-related controls, such as font style, point size, bold and underline.

As noted above, the ribbon is configured such that one tab is viewable at all times. Because each tab can support a relatively large quantity of functionality controls (each control being typically represented by means of a user-intuitive icon and/or descriptive text), the ribbon provides simplified means for activating various functionality controls during the process of generating a document and thereby eliminates the need to navigate through multiple levels of drop-down menus.

Avery Dennison of Pasadena, Calif. presently commercializes a wide variety of printable products under its Avery® line of products. Most printable products sold under the Avery® brand name are constructed in sheet form to enhance compatibility with conventional desktop and inkjet printers.

Commonly, an electronic document that is printed on such a sheet is used to create a particular type of printed article, such as a label, card, tag, tab, insert, badge, cover, sign, binder or the like. In certain instances, the printed article requires separation from the remainder of the sheet (e.g., by removing a printed label from a common carrier sheet or by separating a printed card from the remainder of the sheet through a line of weakness).

Certain types of printable products have unique formatting requirements. For example, a sheet of fourteen labels that are arranged in a particular configuration, or pattern, on a common carrier layer requires that an electronic document intended for printing upon the sheet be formatted to include a plurality of similarly arranged cells. In this manner, when the document is printed on the sheet, the data provided within each cell of the electronic document aligns properly within a corresponding label on the sheet.

Accordingly, templates are well known in the art and are commonly used to prepare electronic documents for printing on particular products. Specifically, templates are often used, inter alia, to format an electronic document into a plurality of discrete cells and to assign a common layout and style of elements (e.g., text boxes, pictures, etc.) within each cell. In this manner, the only task required by the user prior to printing is to modify the variable data associated with the elements in each cell. As a result, a large quantity of printed articles can be mass-produced in an efficient fashion, which is highly desirable.

Each template is typically provided with a particular set of pre-defined, or default, template parameters. As defined herein, use of the term “template parameters” denotes any setting or rule relating to, among other things, (1) the formatting of cells within the electronic document (e.g., the particular size and arrangement of individual cells within the document structure), (2) the layout and style (e.g., color and font) of elements (e.g., text, pictures, etc.) within each cell, (3) the ability/inability to simultaneously modify certain elements in multiple cells (e.g., auto-fill features), and (4) the addition of similarly configured pages to the electronic document.

As can be appreciated, it has been found that ribbon-style user interfaces of the type as described above presently fail to provide functionality controls for regulating template parameters. As a result, conventional ribbons provide users with limited control in preparing an electronic document for printing on a particular product, which is highly undesirable.

### SUMMARY OF THE INVENTION

It is an object of the present invention to provide a new and improved ribbon-style user interface for a software application that can be used to generate a printable electronic document.

It is another object of the present invention to provide a user interface of the type as described above which provides access to a large quantity of functionality controls for the software application.

It is yet another object of the present invention to provide a user interface of the type as described above wherein the functionality controls are displayed in a readily accessible manner.

It is still another object of the present invention to provide a user interface of the type as described above which includes at least one grouping of functionality controls for regulating the parameters of a template used to prepare the electronic document for printing on a particular type of printable office product.

It is yet still another object of the present invention to provide a user interface of the type as described above wherein the selection of functionality controls in the grouping is optimized for the designated product on which the electronic document is printed.

Accordingly, there is provided a ribbon-style user interface for a software application capable of generating a printable electronic document, the printable electronic document being prepared for printing on a particular product using a template that executes within the software application, the template including a pre-designed set of template parameters, the ribbon-style user interface comprising a plurality of tabs arranged in a stacked configuration and a plurality of functionality controls displayed on each of the plurality of tabs, wherein a grouping of the plurality of functionality controls directly relates to the regulation of the active template parameters attributed to the printable electronic document.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a sample screen display for a software application, the sample screen display showing a first embodiment of a ribbon-style user interface which executes within the software application, the ribbon-style user interface being configured according to the teachings of the present invention;

FIG. 2 is another sample screen display for the software application, the screen display depicting a modification to the ribbon-style user interface shown in FIG. 1; and

FIG. 3 is another sample screen display for the software application, the screen display depicting a modification to the ribbon-style user interface shown in FIG. 1.

### DETAILED DESCRIPTION OF THE PREFERRED EMBODIMENT

### Sample Screen Display 11

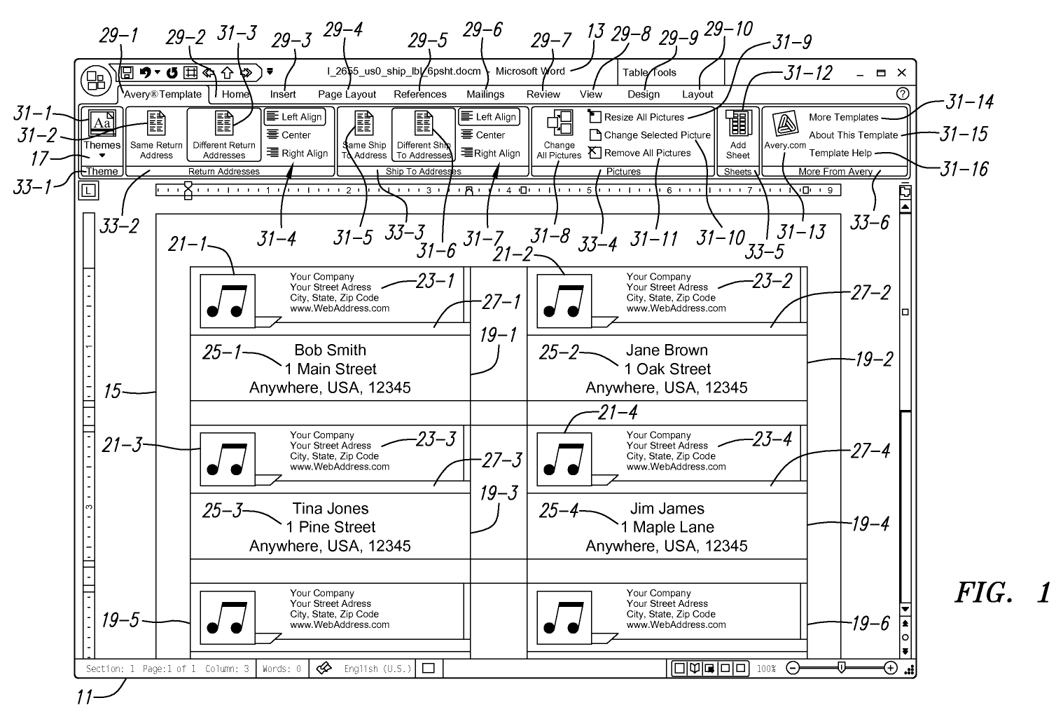

Referring now to FIG. 1, there is shown a sample screen display 11 for a software application 13 which can be used to generate a printable electronic document 15. As can be seen, a ribbon-style user interface is designed to execute within host application 13, the ribbon-style user interface being configured according to the teachings of the present invention and identified generally by reference numeral 17. As will be described further below, ribbon-style user interface 17 is provided with a set of novel features which serves as the foundation of the present invention.

Software application 13 is represented herein as the being in the form of the Microsoft® Word 2007 word processing application. However, as noted briefly above, the present invention relates generally to the particular design of user interface 17. Because user interface 17 is a program module designed to execute within host software application 13, it is to be understood that user interface 17 could similarly execute within other software applications (e.g., Microsoft® Excel 2007 or Microsoft® PowerPoint 2007) without departing from the spirit of the present invention.

A plurality of printing templates, or templates, are configured to execute within software application 13, each template being uniquely designed to prepare (i.e., format) electronic document 15 for printing on a particular type of printable product (e.g., a sheet of labels or cards). When activated, each template prepares document 15 for printing on a specified product using a set of pre-designed, or default, template parameters.

As defined previously above, use of the term “template parameters” denotes any setting or rule relating to, among other things, (1) the formatting of cells within the electronic document (e.g., the particular size and arrangement of individual cells within the document structure), (2) the layout and style (e.g., color and font) of elements (e.g., text, pictures, etc.) within each cell, (3) the ability/inability to simultaneously modify certain elements in multiple cells (e.g., auto-fill features), and (4) the addition of similarly configured pages to the electronic document.

In sample screen display 11, the active template is provided with a pre-design that is useful in printing a plurality of address labels on a single printable sheet of a particular Avery® product. Accordingly, it is to be understood that the pre-design for the active template serves to, inter alia, (1) format document 15 into a plurality of discrete cells 19-1 thru 19-6 which are dimensioned and arranged in the same manner as the layout of labels on the common carrier sheet and (2) assign a common layout and style of variable elements (e.g., text boxes, pictures, background, etc.) within each cell 19. Specifically, in the present example, the pre-design for the active template provides a similar style and arrangement of pictures 21-1 thru 21-4, return addresses 23-1 thru 23-4, ship to addresses 25-1 thru 25-4 and background designs 27-1 thru 27-4 within cells 19-1 thru 19-4, respectively.

### Ribbon-style User Interface 17

Ribbon-style user interface, or ribbon, 17 executes within software application 13 and is preferably located directly above the viewing area of active document 15. Ribbon 17 comprises a plurality of task-based functionality tabs 29-1 thru 29-10 which are layered, or stacked, so that the contents of at most one tab 29 is viewable at a time (with the layout, or stack, of tabs 29 being determined by host application 13). Each tab 29 is configured as an enlarged rectangular, horizontally disposed window on which is displayed a plurality of different functionality controls 31, each control 31 being represented using a user-intuitive icon and/or descriptive text.

As shown herein, tabs 29-1 thru 29-10 are identified, or marked, with the continuously viewable headings of “Avery® Template”, “Home”, “Insert”, “Page Layout”, “References”, “Mailings”, “Review”, “View”, “Design”, and “Layout”, respectively. As can be appreciated, the heading on each tab 29 categorizes the particular groups of functionality controls 31 provided thereon. For example, “home” tab 29-2 may include various commonly-used clipboard controls, such as cut, copy and paste, as well as various commonly-used font-related controls, such as font style, point size, bold and underline.

### Template Tab 29-1

Avery® Template tab 29-1, the contents of which are shown in detail in FIG. 1, displays a series of functionality controls 31 that relate primarily to the regulation of the active template parameters attributed to document 15. As can be appreciated, the integration of template tab 29-1 into ribbon 17 (i.e., without disrupting the functionality of standard tabs 29-2 thru 29-10) as well as the optimized selection of functionality controls 31 provided on template tab 29-1 serve as principal novel features the present invention.

Functionality controls 31 on template tab 29-1 are arranged into a plurality of distinct groupings 33 for improved visibility. Specifically, functionality controls 31 are shown herein as being arranged into a “Theme” grouping 33-1, a “Return Address” grouping 33-2, a “Ship to Address” grouping 33-3, a “Pictures” grouping 33-4, a “Sheets” grouping 33-5 and a “More from Avery” grouping 33-6.

It should be noted that the particular assortment of groupings 33 displayed on template tab 29-1, as well as the array of controls 31 provided within each grouping 33, is preferably optimized (i.e., customized) to accurately reflect the principal attributes of the pre-design for the active template. In this manner, template tab 29-1 meets the particular needs of the user in the most effective fashion. Accordingly, it is to be understood that the particular selection and arrangement of groupings 33 and controls 31 on template tab 29-1 could be modified to more aptly meet the needs of different templates without departing from the spirit of the present invention, as will be discussed further below.

It should also be noted that the particular assortment of groupings 33, as well as the array of controls 31 provided within each grouping 33, need not be limited to display on template tab 29-1. Rather, it is to be understood that certain groupings 33 and controls 31 could be alternatively provided on any of standard tabs 29-2 thru 29-10 without departing from the spirit of the present invention.

Theme grouping 33-1 comprises a theme-related functionality control 31-1 which displays, through the use of a pull-down menu, a number of alternative themes available for document 15. As defined herein, the template “theme” relates to (i) the layout of elements to be included within each cell 19 (e.g., text boxes, pictures, background artwork), and (ii) the style (e.g., color, font, etc.) attributed to said elements within each cell 19.

If the user modifies the theme attributed to document 15 by the active template, it is envisioned that the array of functionality controls 31 provided on template tab 29-1 could be instantaneously modified to more adequately reflect the new theme. For example, if the new theme does not incorporate picture 21 into its design, it is envisioned that picture grouping 33-4 could be removed from template tab 29-1 instantly (i.e., “on the fly”) to reflect this change.

Return address grouping 33-2 includes functionality controls 31 which relate, inter alia, to the ability/inability to simultaneously modify data for return addresses 23-1 thru 23-4. Specifically, grouping 33-2 comprises a “Same Return Address” functionality control 31-2, a “Different Return Addresses” functionality control 31-3 and an array of return address alignment controls 31-4.

Prior to entering return address data into document 15, the active template preferably assigns a default placeholder (e.g., “your company”, “your street address”, etc.) for each return address 23. With control 31-2 activated, the input of return address data into either a dialog box (not shown) or first cell 19-1 automatically fills (i.e., auto-fills) the remaining cells 19 with the same return address, thereby greatly simplifying the data entry process. If control 31-3 is then activated, the return address displayed in cells 19-2 thru 19-4 is returned to its default placeholder and remain as such until the user manually inputs a return address into each cell 19.

Alignment controls 31-4 display the various alignment options (left align, right align and center) that are available for return addresses 23. As can be appreciated, adjusting the setting of alignment control 31-4 serves to similarly adjust the alignment of return addresses 23 throughout all cells 19, which is highly desirable.

Ship to Address grouping 33-3 includes functionality controls 31 which relate, inter alia, to the ability/inability to simultaneously modify data for ship to addresses 25-1 thru 25-4. Specifically, grouping 33-3 comprises a “Same Ship to Address” functionality control 31-5, a “Different Ship to Addresses” functionality control 31-6 and an array of return address alignment controls 31-7.

Prior to entering ship to address data into document 15, the active template preferably assigns a default placeholder for each ship to address 25. With control 31-5 activated, the input of ship to address data into either a dialog box (not shown) or first cell 19-1 automatically fills (i.e., auto-fills) the remaining cells 19 with the same ship to address, thereby greatly simplifying the data entry process. If control 31-6 is then activated, the ship to address displayed in cells 19-2 thru 19-4 is returned to its default placeholder and remain as such until the user manually inputs a ship to address into each cell 19.

Alignment controls 31-7 are similar to controls 31-4 in that controls 31-7 display various alignment options (left align, right align and center) that are available for ship to addresses 25. As can be appreciated, adjusting the setting of alignment control 31-7 serves to similarly adjust the alignment of ship to address 25 throughout all cells 19, which is highly desirable.

Picture grouping 33-4 includes functionality controls 31 which relate, inter alia, to the ability/inability to simultaneously modify pictures 21. Specifically, grouping 33-4 comprises a “Change All Pictures” functionality control 31-8 which, when activated, enables all pictures 21 to be replaced with an alternative picture file through a single automated process (e.g., by changing the picture file for picture 21-1), a “Resize All Pictures” functionality control 31-9 which, when activated, enables all pictures 21 to be resized through a single automated process (e.g., by resizing picture 21-1), a “Change Selected Picture” functionality control 31-10 which, when activated, requires that the picture file for each picture 21 be modified through its own independent process, and a “Remove All Pictures” functionality control 31-11 which, when activated, removes all pictures 21 from document 15.

Sheets grouping 33-5 includes an add sheet functionality control 31-12. When activated, control 31-12 adds an additional sheet to the active document, the added sheet being a direct copy of the first sheet (i.e., with all modifications included).

Information grouping 33-6 includes functionality controls 31 associated with, inter alia, general template-related information. Specifically, information grouping 33-6 comprises an “Avery.com” functionality control 33-13 which is a hyperlink to the www.avery.com website, a “More Templates” functionality control 31-14 which, when activated, provides a list of alternative templates that can be activated in application 13, an “About This Template” functionality control 31-15 which, when activated, provides useful information relating to the active template, and a “Template Help” functionality control 31-16 which, when activated, provides instructions for using the active template.

Optimization of Template Tab 29-1 for Particular Printable Products

As noted above, the particular controls 31 provided on template tab 29-1 are selected in such a manner so as to optimize the functionality of template tab 29-1 with respect to a designated printable product. Accordingly, it is to be understood that the selection of functionality controls 31 on template tab 29-1 could be changed in order to optimize template tab 29-1 for use in conjunction with alternative printable products.

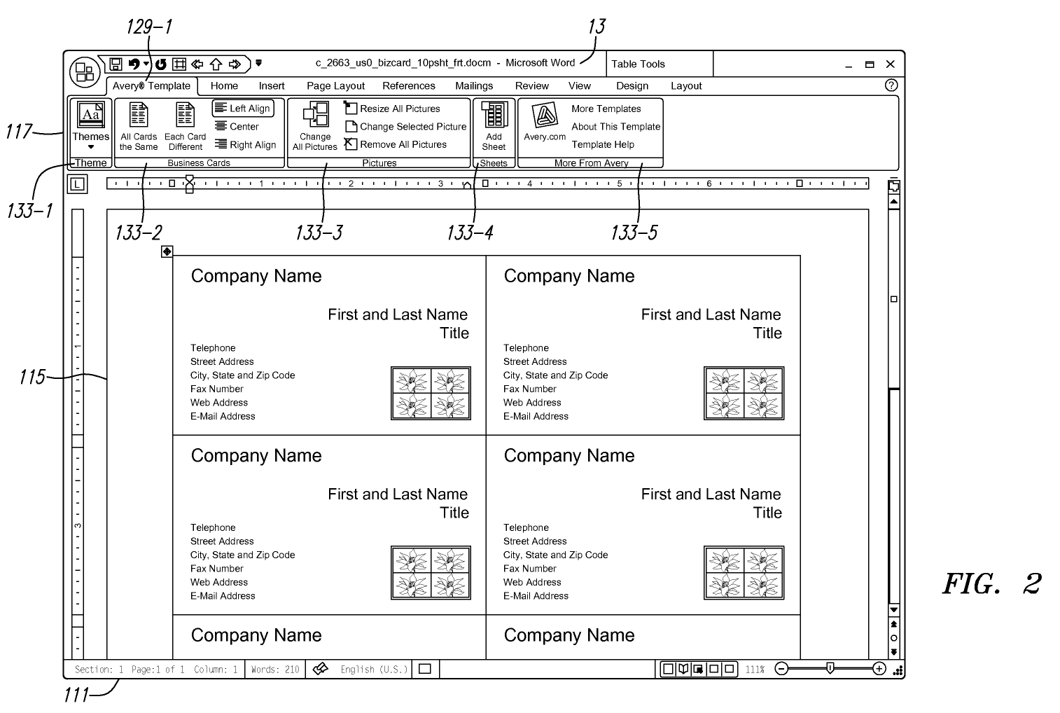

As an example, referring now to FIG. 2, there is shown another sample screen display 111 for software application 13, screen display 111 depicting an alternative printable electronic document 115. Screen display 111 is similar to screen display 11 in that screen display 111 includes a ribbon-style user interface 117 that is designed to execute within host application 13, user interface 117 comprising a template tab 129-1.

In sample screen display 111, the active template prepares document 115 for printing a plurality of business cards on a single printable sheet of a particular Avery® product. In order to optimize the functionality of template tab 129-1, the array of controls 131 provided on template tab 129-1 are selected in view of the pre-design of the active template. Stated another way, template tab 129-1 is customized to most optimally assist in the production of the style of business cards shown in FIG. 2 (whereas template tab 29-1 is customized to most optimally assist in the product of the address labels shown in FIG. 1).

Specifically, because the active template is provided with a pre-design that is useful in printing a plurality of business cards, template tab 129-1 preferably includes a “Theme” grouping 133-1 which functions similarly to theme grouping 33-1, a “Business Cards” grouping 133-2 which, inter alia, enables contact information for each business card to be entered either automatically through a single input process or manually on an individual basis, a “Pictures” grouping 133-3 which functions similarly to pictures grouping 33-4, a “Sheets” grouping 133-4 which functions similarly to sheets grouping 33-5 and a “More From Avery” grouping 133-5 which functions in a similar manner to More from Avery grouping 33-6.

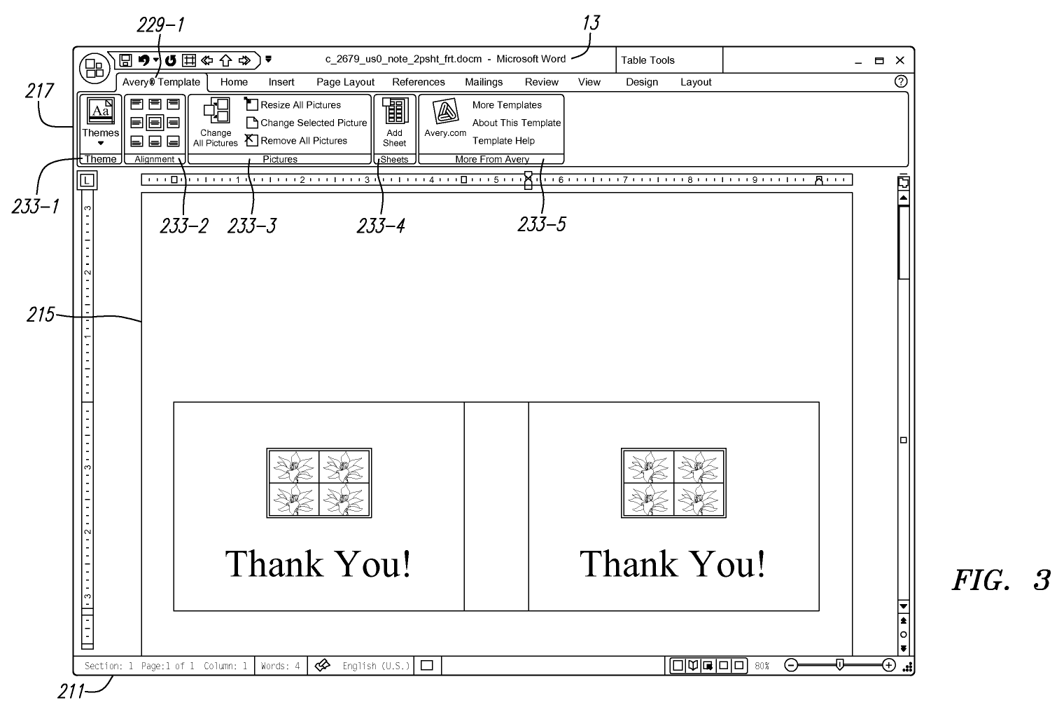

As another example, referring now to FIG. 3, there is shown another sample screen display 211 for software application 13, screen display 211 depicting an alternative printable electronic document 215. Screen display 211 is similar to screen display 11 in that screen display 211 includes a ribbon-style user interface 217 that is designed to execute within application 13, user interface 217 comprising a template tab 229-1.

In sample screen display 211 the active template prepares document 215 for printing a plurality of personalized note cards (e.g., “thank you” notes) on a single printable sheet of a particular Avery® product. In order to optimize the functionality of template tab 229-1, the array of controls 231 provided on template tab 229-1 are selected in view of the pre-design of the active template. Stated another way, template tab 229-1 is customized to most optimally assist in the production of the style of personalized note cards shown in FIG. 3, whereas template tab 129-1 is customized to most optimally assist in the production of the style of business cards shown in FIG. 2 and template tab 29-1 is customized to most optimally assist in the production of the style of address labels shown in FIG. 1.

Specifically, because the active template is provided with a pre-design that is useful in printing a plurality of personalized note cards, template tab 219-1 preferably includes a “Theme” grouping 233-1 which functions similarly to theme grouping 133-1, an “Alignment” grouping 233-2 which, inter alia, allows for the alignment of text-related elements on each note card to be adjusted automatically throughout document 215 through a single process, a “Pictures” grouping 233-3 which functions in a similar manner to pictures grouping 133-3, a “Sheets” grouping 233-4 which functions in a similar manner to grouping 133-4 and a “More from Avery” grouping 233-5 which functions in a similar manner to grouping 133-5.

The embodiments shown in the present invention are intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A ribbon-style user interface for a software application capable of generating a printable electronic document, the printable electronic document being prepared for printing on a particular product using a template that executes within the software application, the template including a pre-designed set of template parameters, the ribbon-style user interface comprising:
(a) a plurality of tabs arranged in a stacked configuration, and
(b) a plurality of functionality controls displayed on each of the plurality of tabs,
(c) wherein a grouping of the plurality of functionality controls directly relates to the regulation of the active template parameters attributed to the printable electronic document.

2. The ribbon-style user interface as claimed in claim 1 wherein the grouping includes functionality controls for modifying the active theme attributed to the document.

3. The ribbon-style user interface as claimed in claim 1 wherein the grouping includes functionality controls for modifying multiple text-related elements in the electronic document.

4. The ribbon-style user interface as claimed in claim 3 wherein the grouping includes functionality controls for modifying the text provided within each of the multiple text-related elements through a single automated process.

5. The ribbon-style user interface as claimed in claim 3 wherein the grouping includes functionality controls for modifying the alignment of text provided within each of the multiple text-related elements through a single automated process.

6. The ribbon-style user interface as claimed in claim 3 wherein the grouping includes functionality controls for modifying the text provided within each of the multiple text-related elements on an individual basis.

7. The ribbon-style user interface as claimed in claim 1 wherein the grouping includes functionality controls for modifying multiple picture-related elements in the electronic document.

8. The ribbon-style user interface as claimed in claim 7 wherein the grouping includes functionality controls for modifying the picture provided within each of the multiple picture-related elements through a single automated process.

9. The ribbon-style user interface as claimed in claim 7 wherein the grouping includes functionality controls for re-sizing each of the multiple picture-related elements through a single automated process.

10. The ribbon-style user interface as claimed in claim 7 wherein the grouping includes functionality controls for modifying the picture provided within each of multiple picture-related elements on an individual basis.

11. The ribbon-style user interface as claimed in claim 7 wherein the grouping includes functionality controls for removing multiple picture-related elements from the electronic document through a single automated process.

12. The ribbon-style user interface as claimed in claim 1 wherein the grouping includes functionality controls for adding a similarly formatted page to the electronic document.

13. The ribbon-style user interface as claimed in claim 1 wherein the grouping includes functionality controls for modifying the active template attributed to the document

14. The ribbon-style user interface as claimed in claim 1 wherein the grouping includes functionality controls for providing information relating to the active template.
